(19) United States
(12) Patent Application Publication
(10) Pub. No.: US 2007/0020407 A1
(43) Pub. Date: Jan. 25, 2007

(54) Elliptically polarizing plate, liquid crystal panel, liquid crystal display device, and image display device

(75) Inventors: Seiji Umemoto, Ibaraki-shi (JP); Yutaka Ohmori, Ibaraki-shi (JP); Michie Sakamoto, Ibaraki-shi (JP); Takashi Kamijou, Ibaraki-shi (JP); Junzou Miyazaki, Ibaraki-shi (JP); Shuusaku Nakano, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi (JP)

(21) Appl. No.: 11/455,107

(22) Filed: Jun. 19, 2006

(30) Foreign Application Priority Data
Jul. 20, 2005 (JP) 2005-210051

(51) Int. Cl. C09K 19/00

(52) U.S. Cl. 428/1.31

(57) ABSTRACT

An elliptically polarizing plate comprising a retardation film having a film comprising a polymer which has, as its main chain, a polyol skeleton having a side chain substituted with at least one chemical group selected from the group consisting of an aromatic carbonyl group, an aryl-substituted lower alkylcarbonyl group, and an unsaturated aliphatic carbonyl group, the chemical group being bonded to an oxygen atom in the polyol skeleton side chain, and a polarizer stacked over the retardation film, wherein the polarizer is made of a coating film obtained by applying a dichromatic colorant. As the dichromatic colorant, an organic colorant represented by (chromogen)(SO₃M)ₙ wherein M represents a cation is used. The elliptically polarizing plate has a good visibility in the range of visible rays and can be made thin and light.

### BACKGROUND OF THE INVENTION

1. Field of the Invention

The present invention relates to an elliptically polarizing plate, as well as a liquid crystal panel, a liquid crystal display device and an image display device each having this elliptically polarizing plate.

2. Description of the Related Art

An elliptically polarizing plate is an optical member wherein a polarizing plate and a retardation film are stacked. Retardation films are optical members for obtaining various polarized lights such as linearly polarized light, circularly polarized light and elliptically polarized light. Among elliptically polarizing plates, an elliptically polarizing plate having a stacked retardation film wherein the retardation thereof is ¼ of a wavelength λ is in particular called a circularly polarizing plate. Elliptically polarizing plates have an optical function of converting linearly polarized light to circularly polarized light, and are widely used in liquid crystal display devices or the like.

As the aforementioned polarizing plate (the polarizing plate is also called as the polarizer or polarizing film), a polyvinyl alcohol drawn film which is caused to adsorb iodine or the like is generally used. As the aforementioned retardation film, a film having birefringent property is used.

Incidentally, the retardation film made of a single layer of a polymer film generally has a function of converting light ray having a specific wavelength into given polarized light, but does not have this function about light rays having different wavelengths. For example, in a retardation film designed to set the retardation thereof to light having a wavelength of 550 nm is λ/4, the retardation thereof to light having a wavelength of 450 nm or 650 nm is not λ/4. In this way, about any retardation film made of a polymer film, the retardation thereof depends on wavelength. It is generally known that the wavelength dispersion thereof becomes larger toward shorter wavelengths and the wavelength dispersion becomes smaller toward longer wavelengths. When white light, in which light rays in the range of visible rays are mixed and synthesized, is radiated into a retardation film exhibiting such a wavelength dispersion, there arises a problem that the state of polarized light at respective wavelengths is different, so that the white light is converted into colored light.

In light of the problem based on this wavelength dispersion, retardation films described below are known. There is known, for example, a retardation film exhibiting given retardations to all light rays in the range of visible rays wherein two or more birefringent media in which wavelength dispersion values α of their birefringence index Δn (α=Δn (450 nm)/Δn (650 nm)) are different are stacked in the state that their slow axes cross at right angles, the wavelength dispersion value α of this retardation film being less than one (see JP-A 10-239518 (1998)).

There is also known a circularly polarizing plate wherein a polarizing plate made of a polyvinyl alcohol-based drawn film which is caused to adsorb iodine or a dichromatic dye is stacked on a laminated retardation film in which an optically anisotropic layer made of a material having a positive in-plane inherent birefringence value is stacked on an optically anisotropic layer made of a material having a negative in-plane inherent birefringence value in such a manner that their optical axes are parallel to each other (see JP-A 2002-40258). This retardation film exhibits a wavelength dispersion that the in-plane retardation in the range of visible rays becomes smaller toward shorter wavelengths and becomes larger toward longer wavelengths (this wavelength dispersion property may be referred to as “reverse wavelength dispersion” hereinafter). For this reason, an elliptically polarizing plate in which this retardation film is stacked gives a good visibility.

However, on the aforementioned elliptically polarizing plate in the conventional art, the polarizing plate made of the iodine-adsorbed polyvinyl alcohol-based film is stacked. The degree that this film is made thin is restrictive; therefore, it is difficult to make the whole of the elliptically polarizing plate thin.

Furthermore, its retardation film is also made of the lamination, in which the birefringence layers, the number of which is two or more, are stacked; therefore, it is more difficult that the aforementioned elliptically polarizing plate, in which this lamination is stacked, is made thin.

### SUMMARY OF THE INVENTION

Thus, an object of the present invention is to provide an elliptically polarizing plate which has a good visibility in the range of visible rays and can be made thin and light. Another object of the present invention is to provide a liquid crystal panel, a liquid crystal display device and an image display device each having this elliptically polarizing plate.

The present invention provides an elliptically polarizing plate comprising: a retardation film having a film comprising a polymer which has, as its main chain, a polyol skeleton having a side chain substituted with at least one chemical group selected from the group consisting of an aromatic carbonyl group, an aryl-substituted lower alkylcarbonyl group, and an unsaturated aliphatic carbonyl group, the chemical group being bonded to an oxygen atom in the polyol skeleton side chain; and a polarizer stacked over the retardation film, wherein the polarizer is made of a coating film obtained by applying a dichromatic colorant.

In a preferred aspect of the present invention, the dichromatic colorant comprises an organic colorant represented by (chromogen)(SO₃M)ₙ wherein M represents a cation.

The present invention also provides a liquid crystal panel comprising a liquid crystal cell having the aforementioned elliptically polarizing plate, and a liquid crystal display device having this liquid crystal panel.

Furthermore, the present invention provides an image display device having the aforementioned elliptically polarizing plate.

The film obtained from the aforementioned polymer exhibits such a wavelength dispersion that the in-plane retardation in the range of visible rays becomes smaller toward shorter wavelengths therein and becomes larger toward longer wavelengths therein. The elliptically polarizing plate of the present invention, wherein a retardation film which has this film and a polarizer which is made of the coating film are stacked, has an excellent visibility since white light radiated into this polarizing plate is not easily converted into colored light by the retardation film exhibiting reverse wavelength dispersion. Moreover, the elliptically polarizing plate can be made thin and light since the polarizer is made of the coating film.

### BRIEF DESCRIPTION OF THE DRAWINGS

FIGS. 1A and 1B are each a vertical sectional view illustrating an embodiment of the elliptically polarizing plate of the present invention;

FIG. 2 is a side view, which contains a partial vertical cross section, illustrating an embodiment of a liquid crystal panel having the elliptically polarizing plate illustrated in FIG. 1A;

FIG. 3 is a graph of wavelength dispersions of retardation films 1 to 4;

FIG. 4 is a graph of wavelength dispersions of retardation films 5 to 7; and

FIG. 5 is a graph of wavelength dispersions of retardation films 8 and 9.

### DETAILED DESCRIPTION OF THE INVENTION

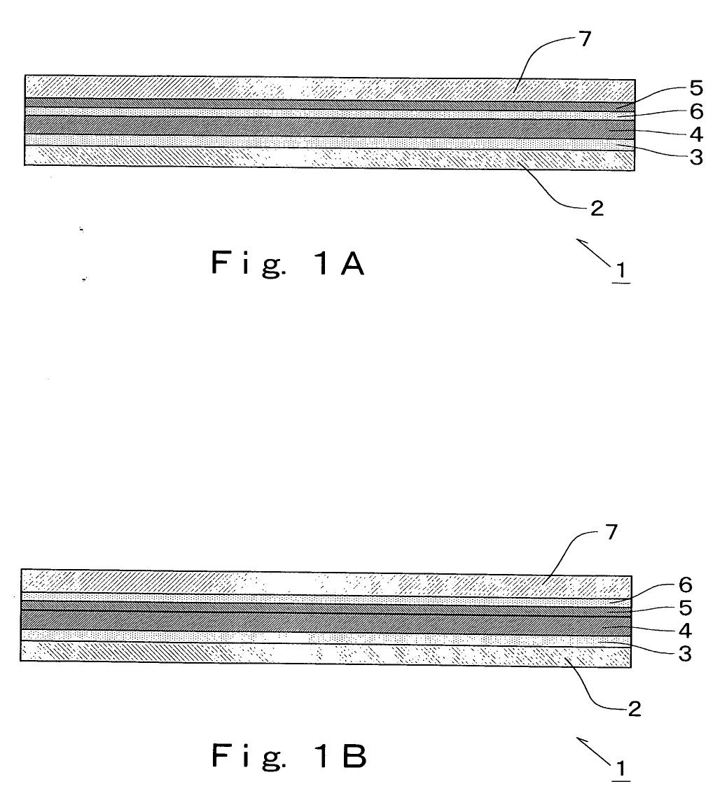

FIGS. 1A and 1B each illustrate an example of the layer structure of the elliptically polarizing plate of the present invention.

In FIGS. 1A and 1B, reference numeral 1 represents an elliptically polarizing plate on which at least a retardation film 4 and a polarizer 5 are stacked; 2, a releasing paper sheet; and 3, an bond layer made of a pressure-sensitive adhesive or an adhesive and formed to bond the elliptically polarizing plate to some other member. The retardation film 4 comprises a modified polymer film described below, and the polarizer 5 is made of a coating film. Reference numerals 6 and 7 represent an bond layer made of a pressure-sensitive adhesive or an adhesive, and a substrate film, respectively.

The present invention will be specifically described hereinafter.

(Retardation Film 4)

The retardation film in the present invention has a birefringent film obtained from a polymer comprising a modified polymer described below. Examples of the form of the retardation film in the present invention include a mono-layered birefringent film obtained from a composition containing the modified polymer, a laminate in which on the birefringent film made of the modified polymer is stacked a different birefringent layer, and a laminate in which on the birefringent film obtained from the modified polymer is stacked a different film. In particular, a mono-layered birefringent film made of a polymer comprising the following modified polymer is preferably used as the retardation film in the present invention since a thinner elliptically polarizing plate can be obtained.

The word “film” in the present specification and claims also means any object which is generally called a “sheet”.

The modified polymer in the present invention is a polymer which has, as its main chain, a polyol skeleton having a side chain substituted with at least one chemical group selected from the group consisting of an aromatic carbonyl group, an aryl-substituted lower alkylcarbonyl group, and an unsaturated aliphatic carbonyl group provided that the chemical group is bonded to an oxygen atom in the polyol skeleton side chain. As will be described later, it is unnecessary that all oxygen atoms in the side chain of the polyol skeleton are modified with the chemical group(s). Thus, it is sufficient that the polymer is a polymer having a side chain wherein oxygen atom(s) are partially modified with the chemical group(s). Accordingly, the modified polymer is a polymer having a moiety where a side chain of its polyol skeleton is/are modified with the chemical group(s).

Examples of the polyol skeleton include a polyvinyl alcohol (PVA) skeleton, and a polyethylene vinyl alcohol (EVOH) skeleton. The PVA skeleton is preferred. Besides the aforementioned chemical group(s), a lower alkylcarbonyl group may be bonded partially to the oxygen atoms in the side chain of the polyol skeleton. This lower alkylcarbonyl group is, for example, an acetyl group (CH₃—CO—).

The aromatic carbonyl group which is one of the chemical groups is represented by, for example, the following formula (1) or (2):

### (Chemical Formula 1)

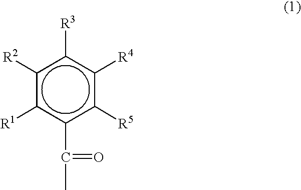 wherein R¹, R², R³, R⁴ and R⁵ may be the same or different and each represent a hydrogen atom or halogen atom, or a hydroxyl, methyl, ethyl, halogenated methyl, halogenated ethyl or nitro (—NO₂) group, or

### (Chemical Formula 2)

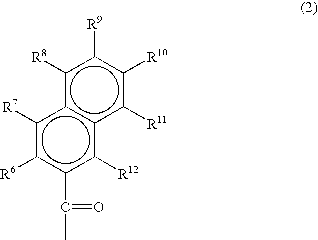 wherein R⁶, R⁷, R⁸, R⁹, R¹⁰, R¹¹ and R¹² may be the same or different and each represent a hydrogen atom or halogen atom, or a hydroxyl, methyl, ethyl, halogenated methyl, halogenated ethyl or nitro (—NO₂) group.

The aromatic carbonyl group represented by the formula (1) is preferably, for example, a benzoyl group (C₆H₅—CO—), which is a group wherein R¹ to R⁵ are each a hydrogen atom.

The aryl-substituted lower alkylcarbonyl group is represented by, for example, Ar—(CH₂)ₙ—CO— wherein Ar is an aromatic ring and n is an integer of 1 to 2, preferably n is 1 (an aryl-substituted methylcarbonyl group: Ar—CH₂—CO—).

The aryl-substituted lower alkylcarbonyl group can be specifically represented by the following formula (3) or (4):

### (Chemical Formula 3)

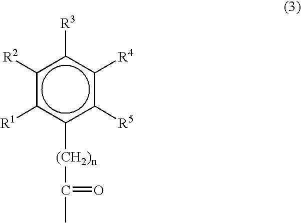 wherein R¹, R², R³, R⁴ and R⁵ may be the same or different and each represent a hydrogen atom or halogen atom, or a hydroxyl, methyl, ethyl, halogenated methyl, halogenated ethyl or nitro (—NO₂) group, and n is an integer of 1 to 2, preferably n is 1 (an aryl-substituted methylcarbonyl group), or

### (Chemical Formula 4)

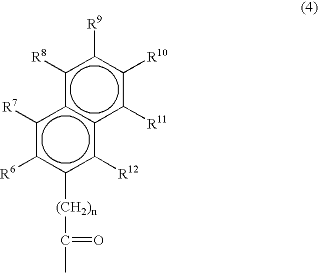 wherein R⁶, R⁷, R⁸, R⁹, R¹⁰, R¹¹ and R¹² may be the same or different and each represent a hydrogen atom or halogen atom, or a hydroxyl, methyl, ethyl, halogenated methyl, halogenated ethyl or nitro (—NO₂) group, and n is an integer of 1 to 2, preferably n is 1 (an aryl-substituted methylcarbonyl group).

The chemical group(s) preferably comprise(s) at least one of the aromatic carbonyl group and the aryl-substituted lower alkylcarbonyl group. The aryl-substituted lower alkylcarbonyl group is preferably an aryl-substituted methylcarbonyl group (Ar—CH₂—CO—), wherein n is 1 in each of the aforementioned formulae. In the case of the aromatic carbonyl group or the aryl-substituted methylcarbonyl group, the number of carbon atoms between the main chain and the aromatic ring of the chemical group is 1 or 2. When the number of the carbon atoms is 1 or 2 in this way, for example, the modified polymer is used to form a film, whereby the obtained film can be a very rigid film. Moreover, the freedom degree of the side chain of the polymer is more restricted, and thus reverse wavelength dispersion is more easily realized. This would be based on the following reason. When a polymer film is drawn, the main chain of the polymer is usually oriented in the direction of the draw. Accordingly, its side chain is also oriented in the same direction. However, when a polymer has an aromatic ring as described above and further the number of carbon atoms as described above is set to one or two, the freedom degree of its side chain can be further limited. For this reason, the orientation of the side chain in the draw direction is sufficiently restrained in the same manner as that of the main chain, so that the side chain can easily be oriented perpendicularly to the main chain. As a result, on the basis of the chemical group(s) bonded to the side chain, the retardation film using this polymer film appears to exhibit the property of reverse wavelength dispersion sufficiently.

The unsaturated aliphatic carbonyl group is preferably, for example, a group having at least one of a double bond and a triplet bond. Specific examples thereof include a group represented by any one of the following formulae (5) to (7):

### (Chemical Formula 5)

### (Chemical Formula 6)

### (Chemical Formula 7)

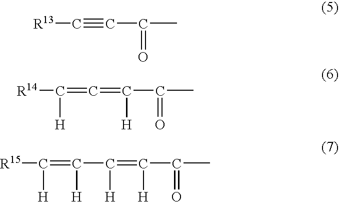 wherein R¹³, R¹⁴ and R¹⁵ are each a hydrogen atom or halogen atom, or a hydroxyl, methyl, ethyl, halogenated methyl, halogenated ethyl or nitro (—NO₂) group.

Of the unsaturated aliphatic carbonyl groups, the chemical group represented by the formula (5) is preferred, and a propioloyl group (CH≡C—CO—), wherein R¹³ is a hydrogen atom in the formula (5), is preferred.

The modification ratio of the polyol skeleton based on the aforementioned chemical group is preferably in the range of 1 to 20% of the number of all carbon atoms in the main chain of the polyol skeleton, more preferably in the range of 4 to 20% thereof, even more preferably in the range of 4 to 15% thereof.

Since the modified polymer has in its main chain a polyolefin skeleton, the glass transition temperature thereof is usually in the range of 80 to 180° C.

The following will describe an example of the process for producing the aforementioned modified polymer.

The modified polymer can be obtained, for example, by causing a polymer having a polyol skeleton as its main chain, which may be referred to as a “starting polymer”, to react with at least one modifying compound selected from the group consisting of an aromatic carboxylic acid, an aromatic carboxylic acid halide, an aromatic carboxylic acid anhydride, an aryl-substituted lower alkylcarboxylic acid, an aryl-substituted lower alkylcarboxylic acid halide, an aryl-substituted lower alkylcarboxylic acid anhydride, an aromatic ketone, an aromatic aldehyde, an unsaturated aliphatic carboxylic acid, an unsaturated aliphatic carboxylic acid halide, an unsaturated aliphatic carboxylic acid anhydride, an unsaturated aliphatic ketone, and an unsaturated aliphatic aldehyde. According to this production process, for example, between a hydroxyl group of the starting polymer and a functional group (such as a carboxyl, halogenated carbonyl or carbonyl group) of the modifying compound, a reaction (such as dehydration or dehydrogenhalogenation) is generated. By this reaction, a bond (such as an ester bond) is formed between the aforementioned chemical group and the oxygen atom in the side of the starting polymer, so as to yield a modified polymer having the aforementioned structure.

Examples of the polymer having a polyol skeleton (starting polymer) include polyvinyl alcohol (PVA) and polyethylene vinyl alcohol (EVOH). PVA is preferred. Usually, PVA is produced by saponifying polyvinyl acetate, and EVOH is produced by saponifying ethylene-vinyl acetate copolymer (EVA). The saponification degree thereof is not particularly limited, and is, for example, in the range of 40 to 100%, preferably in the range of 60 to 100%, more preferably in the range of 80 to 100%. The modification ratio based on the chemical group can be controlled by the saponification degree of PVA or EVOH. This control will be described later.

Since the saponification degree of the starting polymer is not particularly limited, the starting polymer may be a polymer wherein lower alkylcarbonyl groups such as acetyl groups (—CH₃—CO—) are bonded to some ones out of oxygen atoms in the side chain(s) of a polyol skeleton.

The aromatic carboxylic acid is represented by, for example, RCOOH. The aromatic carboxylic acid halide is represented by, for example, RCOZ. The aromatic carboxylic acid anhydride is represented by, for example, (RCO)₂O. In each of the formulae, R is represented by the following general formula (8) or (9), and Z is a halogen atom:

### (Chemical Formula 8)

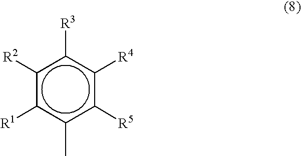 wherein R¹, R², R³, R⁴ and R⁵ may be the same or different and each represent a hydrogen atom or halogen atom, or a hydroxyl, methyl, ethyl, halogenated methyl, halogenated ethyl or nitro (—NO₂) group, or

### (Chemical Formula 9)

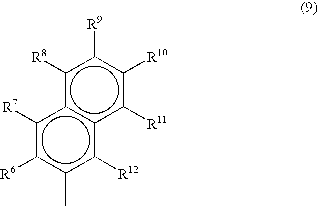 wherein R⁶, R⁷, R⁸, R⁹, R¹⁰, R¹¹ and R¹² may be the same or different and each represent a hydrogen atom or halogen atom, or a hydroxyl, methyl, ethyl, halogenated methyl, halogenated ethyl or nitro (—NO₂) group.

Of the aforementioned modifying compounds, preferred is the aromatic carboxylic acid halide RCOZ. Particularly preferred is benzoyl chloride (C₆H₅COCl), wherein R is represented by the formula (8), R¹ to R⁵ in the formula (8) are each a hydrogen atom and Z is chlorine (Cl).

The aryl-substituted lower alkylcarboxylic acid is represented by, for example, Ar—(CH₂)ₙ—COOH. The aryl-substituted lower alkylcarboxylic acid halide is represented by, for example, Ar—(CH₂)ₙ—COZ. The aryl-substituted lower alkylcarboxylic acid anhydride is represented by, for example, (Ar—(CH₂)ₙ—CO)₂O. In each of the formulae, Ar is an aromatic ring, Z is a halogen atom, and n is an integer of 1 to 2, preferably 1 (an aryl-substituted methylcarboxylic acid, an aryl-substituted methylcarboxylic acid halide, or an aryl-substituted methylcarboxylic acid anhydride).

Specifically, the aryl-substituted lower alkylcarboxylic acid, the aryl-substituted lower alkylcarboxylic acid halide, and the aryl-substituted lower alkylcarboxylic acid anhydride are represented by, for example, R′COOH, R′COZ, and (R′CO)₂O, respectively. In each of the formulae, R′ is represented by the following formula (10) or (11), and Z is a halogen atom:

### (Chemical Formula 10)

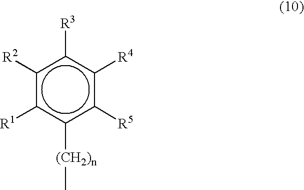 wherein R¹, R², R³, R⁴ and R⁵ may be the same or different and each represent a hydrogen atom or halogen atom, or a hydroxyl, methyl, ethyl, halogenated methyl, halogenated ethyl or nitro (—NO₂) group, and n is an integer of 1 to 2, preferably 1, or

### (Chemical Formula 11)

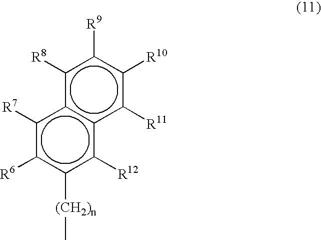 wherein R⁶, R⁷, R⁸, R⁹, R¹⁰, R¹¹ and R¹² may be the same or different and each represent a hydrogen atom or halogen atom, or a hydroxyl, methyl, ethyl, halogenated methyl, halogenated ethyl or nitro (—NO₂) group, and n is an integer of 1 to 2, preferably 1.

Preferred examples of the modifying compound include the aforementioned aromatic carboxylic acid, aromatic carboxylic acid halide, aromatic carboxylic acid anhydride, aryl-substituted lower alkylcarboxylic acid, aryl-substituted lower alkylcarboxylic acid halide, aryl-substituted lower alkylcarboxylic acid anhydride. The aryl-substituted lower alkylcarboxylic acid, the aryl-substituted lower alkylcarboxylic acid halide, and the aryl-substituted lower alkylcarboxylic acid anhydride are preferably an aryl-substituted methylcarboxylic acid, an aryl-substituted methylcarboxylic acid halide, and an aryl-substituted methylcarboxylic acid anhydride, wherein n is 1 in each of the aforementioned formulae, respectively. When any one of these modifying compounds is used to produce a modified polymer, in the polymer the number of carbon atoms between its main chain and the aromatic ring in the chemical group becomes 1 or 2. Accordingly, advantageous effects as described above can be obtained.

It is preferred that the unsaturated aliphatic carboxylic acid, the unsaturated aliphatic carboxylic acid halide and the unsaturated aliphatic carboxylic acid anhydride each have at least one of a double bond and a triple bond. The unsaturated aliphatic carboxylic acid is represented by, for example, R″COOH. The unsaturated aliphatic carboxylic acid halide is represented by, for example, R″COZ. The unsaturated aliphatic carboxylic acid anhydride is represented by, for example, (R″CO)₂O. In each of the formulae, R″ is represented by any one of the following formulae (12) to (14), and Z is a halogen atom:

### (Chemical Formula 12)

### (Chemical Formula 13)

### (Chemical Formula 14)

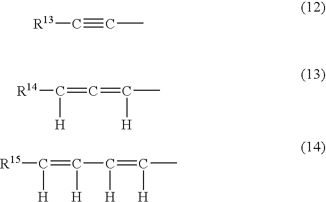 wherein R¹², R¹³ and R¹⁴ are each a hydrogen atom or halogen atom, or a hydroxyl, methyl, ethyl, halogenated methyl, halogenated ethyl or nitro (—NO₂) group.

Of the unsaturated aliphatic carboxylic acid, the unsaturated aliphatic carboxylic acid halide and the unsaturated aliphatic carboxylic acid anhydride, preferred is the unsaturated aliphatic carboxylic acid represented by R″COOH. Particularly preferred is propiolic acid (CH≡C—COOH), wherein R″ is represented by the formula (12) and R¹³ is hydrogen.

About each of the modifying compound and the starting polymer, a single kind thereof may be used or two or more kinds thereof may be used.

The aforementioned starting polymer is dissolved into a solvent to prepare a polymer solution. The kind of the solvent can be appropriately decided in accordance with the kind of the starting polymer. Examples of the solvent include pyridine, chlorine-containing solvents such as methylene chloride, trichloroethylene, and tetrachloroethane, ketone solvents such as acetone, methyl ethyl ketone (MEK), and cyclohexane, aromatic solvents such as toluene, cyclic alkanes such as cycloheptane, amide solvents such as N-methylpyrrolidone, and ether solvents such as tetrahydrofuran. These may be used alone or in combination of two or more thereof.

The dissolution of the starting polymer is preferably attained under a drying condition. For example, the starting polymer itself may be dried in advance.

The modifying compound is further added to the polymer solution to cause the starting polymer and the modifying compound to react with each other. By adjusting the amount of the added modifying compound, the introduction ratio of the modifying compound into the starting polymer (modification rate based on the chemical group) can be controlled. This control will be described later.

The reaction is preferably conducted under a heating condition. The reaction temperature is not particularly limited, and is usually in the range of 25 to 60° C. The reaction time is usually in the range of 2 to 8 hours. If the reaction temperature is lower than the aforementioned temperature for the dissolving treatment of the starting polymer, for example, it is preferred to lower the temperature of the polymer solution once to the reaction temperature and then add thereto the modifying compound. It is also preferred to conduct the reaction while stirring the reaction solution containing the starting polymer and the modifying compound. The reaction may be conducted in the presence of a catalyst. A catalyst known in the conventional art, for example, p-toluenesulfonic acid monohydride or some other acid catalyst can be used.

From this reaction solution, a modified polymer, which is a reaction product, is collected. The collection of the modified polymer can be performed, for example, as follows.

First, a solvent such as acetone is added to the reaction solution, and a filtrate is collected. Water is added to this filtrate to precipitate the modified polymer. The precipitation is separated by filtration, whereby the modified polymer can be collected. The collected precipitation is usually white. Preferably, the collected modified polymer is further stirred in water so as to be washed. After the washing, the collected modified polymer is dried under a reduced pressure, whereby the modified polymer in a dry state can be obtained.

In the production of the modified polymer, the introduction ratio of the modifying compound into the polyol skeleton of the starting polymer (the modification ratio based on the chemical group) is set preferably into the range of 1 to 20% of the number of all carbon atoms in the main chain, more preferably into the range of 4 to 20% thereof, even more preferably into the range of 4 to 15% thereof.

The introduction ratio of the modifying compound into the starting polymer (the modification ratio based on the chemical group) can be controlled, for example, as follows.

A first method for the control is a method of selecting the starting polymer having an appropriate saponification degree. Specifically, when conditions for the reaction, such as the addition ratio between the starting polymer and the modifying compound and the temperature therefor, are the same, for example, the introduction ratio of the modifying compound (the modification ratio) can be made high by using the starting polymer having a relatively high saponification degree, and the introduction ratio of the modifying compound (the modification ratio) can be made low by using the starting polymer having a relatively low saponification degree.

A second method for the control is a method of adjusting the addition ratio between the starting polymer and the modifying compound. Specifically, the introduction ratio (modification ratio) can be made high by making the addition ratio of the modifying compound to the starting polymer relatively high, and the introduction ratio (modification ratio) can be made low by making the addition ratio of the modifying compound to the starting polymer relatively low.

A third method for the control is a method of causing the starting polymer to react with the modifying compound to bond the chemical group therefrom to the starting polymer and then subjecting the resultant to hydrolysis or some other treatment, thereby removing the bonded chemical group.

By a method as described above, the modified polymer can be produced. The modification ratio based on the chemical group in the modified polymer can be detected by, for example, ¹H-NMR.

Next, a polymer containing one or more modified polymers as described above is made into a film, and then the film is subjected to drawing treatment, whereby a birefringent film exhibiting reverse wavelength dispersion can be obtained. The method for producing the film is not particularly limited, and examples thereof include film-forming methods known in the conventional art, such as a solution casting method and melting extrusion. The modified polymer may be used alone or in combination of two or more thereof. For example, according to the solution casting method, a solution of the polymer or a melted solution of the polymer is developed (applied) onto a substrate, and the applied film is solidified, whereby the film can be produced. For example, the modified polymers having different modification ratios, the modified polymers having different chemical groups, or the modified polymers obtained from different starting polymers can be used in the form of a mixture thereof.

The solution of the polymer can be prepared, for example, by dissolving the modified polymer(s) into a solvent. Examples of the solvent include dimethylsulfoxide (DMSO); halogenated hydrocarbons such as chloroform, dichloromethane, carbon tetrachloride, dichloroethane, tetrachloroethane, trichloroethylene, tetrachloroethylene, chlorobenzene, and o-dichlorobenzene; phenols such as phenol and p-chlorophenol; aromatic hydrocarbons such as benzene, toluene, xylene, methoxybenzene, and 1,2-dimethoxybenzene; ketone solvents such as acetone, methyl ethyl ketone, methyl isobutyl ketone, cyclohexanone, cyclopentanone, 2-pyrrolidone, N-methyl-2-pyrrolidone; ester solvents such as ethyl acetate, and butyl acetate; alcohol solvents such as t-butyl alcohol, glycerin, ethylene glycol, triethylene glycol, ethylene glycol monomethyl ether, diethylene glycol dimethyl ether, propylene glycol, dipropylene glycol, and 2-methyl-2,4-pentanediol; amide solvents such as dimethylformamide, dimethylacetoamide; nitrile solvents such as acetonitrile and butyronitrile; ether solvents such as diethyl ether, dibutyl ether and tetrahydrofuran; carbon disulfide; ethylcellosolve; and butylcellosolve. These solvents may be used alone or in combination of two or more thereof.

The addition ratio of the polymer is not particularly limited and, for example, the amount of the polymer is preferably in the range of 5 to 50 parts by weight for 100 parts by weight of the solvent, more preferably in the range of 10 to 40 parts by weight therefor. If necessary, various additives may be added to the polymer solution, examples of the additives including a stabilizer, a plasticizer, and a metal. A different polymer may be added to the polymer solution as long as the reverse wavelength dispersion property of the resultant film is not affected.

The method for the development of the polymer solution is not particularly limited, and a method known in the conventional art can be adopted, examples of the method including spin coating, roll coating, flow coating, printing, dip coating, casting film-forming, bar coating, gravure printing, die coating, curtain coating methods. The solidification of the applied film can be performed by, for instance, natural drying or drying. Conditions therefor are not particularly limited, either. The temperature is usually from 40 to 300° C., preferably from 50 to 250° C., more preferably from 60 to 200° C. The drying of the applied film may be performed at a constant temperature, or may be performed while the temperature is stepwise raised or lowered. The time for the drying is not particularly limited, either, and is usually from 10 seconds to 30 minutes, preferably from 30 seconds to 25 minutes, more preferably from 1 to 20 minutes.

The formed film is subjected to, for example, drawing treatment or shrinking treatment, whereby a retardation is expressed therein. In this way, a birefringent film can be obtained.

About the drawing treatment, the kind (for example, uniaxial drawing or biaxial drawing) of the drawing or conditions therefor (for example, the draw ratio) can be appropriately decided in accordance with a desired retardation. It is allowable to stick a shrinkable film, which is shrinkable near the temperature for the drawing, onto the film in advance, and then subject the films to uniaxial drawing. This method is disclosed in JP-A 05-157911 (1993). According to this method, a birefringent film can easily be produced, an example of which is a birefringent film wherein the refractive index in the thickness direction is larger than the in-plane refractive index and N_{z}, which will be detailed later, is less than 1.

The drawing of the film is conducted preferably at a temperature higher than the glass transition temperature of the modified polymer in the present invention. In general, the temperature for the drawing is preferably a temperature 5 to 50° C. higher than the glass transition temperature, and is more preferably a temperature 10 to 40° C. higher than the glass transition temperature.

The thickness of the resultant birefringent film is not particularly limited, and is, for example, from 5 to 500 μm, preferably from 10 to 200 μm, more preferably from 20 to 100 μm.

In the birefringent film of the aforementioned modified polymer, the in-plane retardation at a wavelength of 450 nm (Δnd (450 nm)) and the in-plane retardation at a wavelength of 550 nm (Δnd (550 nm)) satisfy the following expression:
Δnd(450 nm)/Δnd(550 nm)<1

This demonstrates that as the wavelength (X nm) of incident light becomes longer, the in-plane retardation Δnd (X nm) at the wavelength (X nm) tends to become larger. The retardation film of the present invention, which has such a birefringent film, exhibits the property of reverse wavelength dispersion, and forms of polarized light at all wavelengths of incident light are substantially the same. Consequently, according to any elliptically polarizing plate having this retardation film, at the time of radiating white color into this plate, the white color is never converted into colored polarized light. The wavelength (X nm) is generally in the range of 450 to 650 nm, or 400 to 700 nm.

Δnd is represented by (nx−ny)·d, wherein nx and ny represent the refractive index in the X axis direction and that in the Y axis direction of the film, respectively, and d represents the thickness of the film. The X axis direction is the direction of an axis along which the maximum refractive index is shown in the plane of the film, and the Y axis direction is the direction of an axis perpendicular to the X axis in the plane of the film.

About the aforementioned expression Δnd (450 nm)/Δnd (550), more preferred is 0.6≦Δnd (450 nm)/Δnd (550 nm)<1, and even more preferred is 0.7≦Δnd (450 nm)/Δnd (550 nm)≦0.9.

About the birefringent film, the in-plane retardation at a wavelength of 650 nm (Δnd (650 nm)) and that at a wavelength of 550 nm (Δnd (550 nm)) preferably satisfy 1<Δnd (650 nm)/Δnd (550 nm), more preferably satisfy 1<Δnd (650 nm)/Δnd (550 nm)≦2, and even more preferably satisfy 1.1≦Δnd (650 nm)/Δnd (550 nm)≦1.3.

The value of the retardation can be varied by controlling, for example, the modification ratio based on the chemical group in the modified polymer. Besides, several modified polymers having different modification ratios are prepared and these are mixed at a given ratio, thereby making it possible to give a desired reverse dispersion obtained by varying the wavelength dispersion property. When modified polymers are mixed at a given ratio in this way, the modification ratio of the whole of the mixture is preferably from 1 to 20% of the number of all carbon atoms in the main chains.

The birefringent film of the modified polymer described hereinbefore expresses an in-plane retardation and further exhibits reverse wavelength dispersion. The film is more preferably a film exhibiting, for example, an optical property called optical uniaxial property “nx>ny=nz” or optical biaxial property “nx>ny>nz”, “nx>nz>ny”. Such an optical property as optical uniaxial property or optical biaxial property can be set by a method known in the conventional art, for example, a method of adjusting the kind of the drawing treatment or conditions therefor. Similarly, the in-plane retardation or the thickness-direction retardation at a given wavelength can also be set by a method known in the conventional art. Examples of this method include a method of setting appropriately the kind of the drawing treatment or conditions therefor, or the thickness of the used film.

In the retardation film of the present invention, the layer structure thereof is not limited as long as the plate has the aforementioned birefringent film. The retardation film is made of a monolayer of the birefringent film made of the modified polymer, or is made of a laminate wherein a different birefringent layer is laminated thereon as long as the reverse wavelength dispersion thereof is not damaged.

In the retardation film of the present invention, the in-plane retardation Δnd (550 nm) is preferably from 10 to 1000 nm. When the retardation film is used as, for example, a λ/4 plate, wherein the retardation to a wavelength λ is ¼, the Δnd (550 nm) is preferably in the range of 100 to 170 nm. When the retardation film is used as, for example, a λ/2 plate, the Δnd (550 nm) is preferably in the range of 200 to 340 nm.

Since the retardation film of the present invention has a birefringent film made of the aforementioned modified polymer, the retardation film can be made into an optical member having reverse wavelength dispersion, and can realize a function as a λ/4 plate, a λ/2 plate or the like in a wide wavelength band. Preferably, the retardation film is, for example, a λ/4 plate, or a λ/2 plate.

In the retardation film of the present invention, the Nz coefficient thereof, which is represented by the following equation showing a relationship between the thickness direction birefringence index (nx−nz) and the in-plane birefringence index (nx−ny): Nz=(nx−nz)/(nx−ny), preferably satisfies, for example, the following expression: 0<Nz<1. When one out of retardation films of the present invention is used in a liquid crystal cell, the Nz preferably satisfies: 0.3<Nz<0.7. When two out of retardation films of the present invention are used, it is preferred to set the Nz of one thereof to satisfy 0.3<Nz<0.7, set the Nz of the other to satisfy 0.1<Nz<0.4, and combine the two plates.

In any ordinary retardation film produced by uniaxial drawing (uniaxial retardation film), the Y axis direction refractive index (ny) and the Z axis direction refractive index (nz) are equal to each other. Thus, the Nz coefficient is 1. When this retardation film is inclined to the slow axis thereof, the retardation thereof generally becomes larger as the inclined angle becomes larger. However, in the case that the Nz coefficient of a retardation film satisfies 0<Nz<1 as described above, the retardation change to a change in the inclined angle becomes smaller than in the case of the aforementioned ordinary uniaxial retardation film. In particular, when the Nz is 0.5, the retardation hardly changes if the inclined angle is, for example, about 60°. Also, in the case that the retardation film is inclined to the fast axis thereof, the retardation change becomes still smaller as the Nz coefficient is nearer to 0.5. In other words, the rate of the retardation change observed with a change in the inclined angle continuously changes correspondingly to the Nz coefficient. However, the retardation change based on a change in the inclined angle can be sufficiently restrained when the Nz is in particular within a range of 0<Nz<1 as described above.

When an ordinary uniaxial retardation film (Nz=1) is arranged to set the slow axis thereof to 45° to the inclined axis thereof, the axial angle changes in such a manner that the slow axis gets closer to a parallel to the inclined axis as the inclined angle becomes larger. On the other hand, in the retardation film satisfying 0<Nz<1, the amount of change in the axial angle also becomes smaller than in the ordinary uniaxial retardation film. Specifically, in a retardation film having a Nz of 0.5, the axial angle hardly changes from 45°.

(Polarizer 5, Substrate Film 7, and the Like)

The polarizer is made of a coating film obtained by applying a solution containing a dichromatic colorant.

The dichromatic colorant containing solution is not particularly limited if this can be applied to form a film, whereby polarized light can be obtained. As the dichromatic colorant containing solution, for example, a lyotropic liquid crystalline dichromatic colorant, a liquid crystal polymer which contains a dichromatic dye colorant, or the like can be used. Examples of a polarizer of a coating film made of the latter liquid crystal polymer, which contains a dichromatic dye colorant, are described in JP-A 11-101964 (1999).

It is particularly preferred to use a solution containing, as a lyotropic liquid crystalline, dichromatic colorant, an organic colorant represented by the following general formula (15): (chromogen)(SO₃M)n wherein M represents a cation.

This is because the colorant is excellent in heat resistance and light resistance.

In the formula (15), M is preferably a hydrogen ion, an ion of a metal in the group I such as Li, Na, K or Cs, or an ammonium ion.

In the organic colorant represented by the general formula (15) in the solution, the chromogen, such as an azo compound or a polycyclic compound structure, is a hydrophobic moiety, and further the sulfonic acid or salt thereof is a hydrophilic moiety. In molecules of the colorant, their hydrophobic moieties gather and their hydrophilic moieties gather by the balance between the hydrophobic moieties and the hydrophilic moieties. Thus, lyotropic liquid crystallinity is expressed as a whole.

Specific examples of the organic colorant represented by the general formula (15) include the following general formulae (16) to (22):

### (Chemical Formula 16)

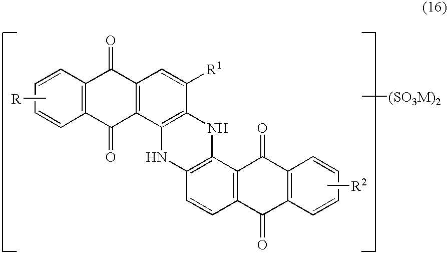

In the formula (16), R¹ is hydrogen or chlorine, R² is hydrogen, an alkyl group, ArNH, or ArCONH, and M is the same as in the general formula (15). The alkyl group is preferably an alkyl group having 1 to 4 carbon atoms, more preferably a methyl or ethyl group. The aryl group (Ar) is preferably a substituted or unsubstituted phenyl group, more preferably an unsubstituted phenyl group or a phenyl group wherein hydrogen at the 4-position is substituted with chlorine.

### (Chemical Formula 17)

### (Chemical Formula 18)

### (Chemical Formula 19)

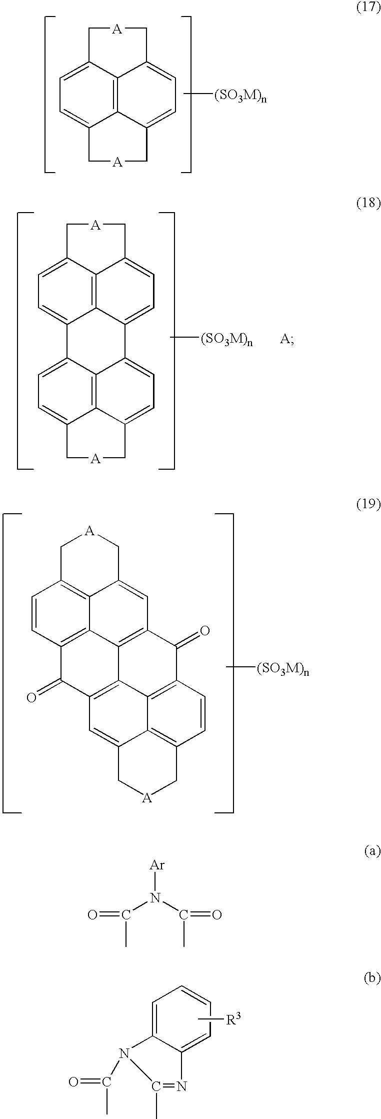

In the formulae (17) to (19), A is represented by the formula (a) or (b) (wherein R³ represents hydrogen, an alkyl group, a halogen, or an alkoxy group, and Ar represents a substituted or unsubstituted aryl group), n is 2 or 3, and M is the same as in the formula (15). The alkyl group is preferably an alkyl group having 1 to 4 carbon atoms, more preferably a methyl or ethyl group. The halogen is preferably bromine or chlorine. The alkoxy group is preferably an alkoxy group having 1 to 2 carbon atoms, more preferably a methoxy group. The aryl group is preferably a substituted or unsubstituted phenyl group, more preferably an unsubstituted phenyl group or a phenyl group wherein hydrogen at the 4-position is substituted with a methoxy group, an ethoxy group, chlorine or a butyl group, or wherein hydrogen at the 3-position is substituted with a methyl group.

### (Chemical Formula 20)

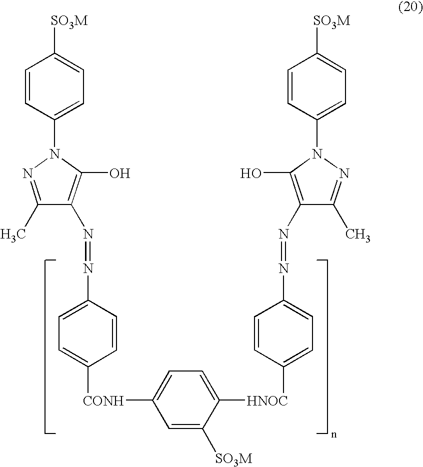

In the formula (20), n is from 3 to 5, and M is the same as in the general formula (15).

### (Chemical Formula 21)

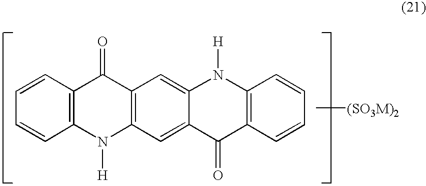

### (Chemical Formula 22)

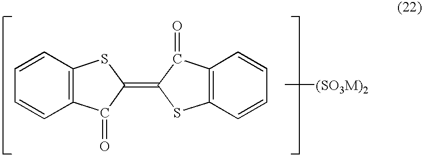

In the formulae (21) and (22), M is the same as in the general formula (15).

One or more out of lyotropic liquid crystalline, dichromatic colorants represented by the general formula (15) are dissolved into an appropriate solvent such as water, acetone, alcohol or dioxane, and further this solution is applied so as to act shearing force thereon, and solidified, thereby making it possible to form a coating film having a polarizing function of taking out ordinary ray.

The concentration of solids in the solution containing the lyotropic liquid crystalline, dichromatic colorant(s) is preferably adjusted into the range of about 1 to 25% by weight. The dichromatic colorants of the general formulae (16), (18), (19) and (20) exhibit stable liquid crystallinity at a concentration of about 5 to 25% by weight. The dichromatic colorant of the general formulae (17), (21) and (22) exhibit stable liquid crystallinity at a Concentration of about 16 to 20% by weight.

The method for applying the solution containing the dichromatic colorant(s) so as to act shearing force thereon is not particularly limited, and may be a known method such as bar coating, roll coating, lip coating, comma coating, or gravure coating.

The solution containing the dichromatic colorant(s) is applied onto, for example, a substrate film, which will be detailed later, or the aforementioned retardation film. The solvent is volatized or evaporated to be solidified, thereby making it possible to form a coating film having a polarizing function as an optical member for taking out ordinery ray (that is, a polarizer of the present invention) on one of the surfaces of the substrate film or the retardation film.

In the polarizer formed by applying in this way, the thickness thereof can be set to 20 μm or less. The thickness can be set preferably into the range of 0.1 to 10 μm, more preferably in the range of 0.2 to 5 μm.

Accordingly, about this polarizer, the film thickness can be made far smaller than about conventional polarizers each made of a iodine-absorbed polyvinyl alcohol drawn film.

The substrate film, which is used to form the coating film, is not particularly limited if the film is excellent in transparency. The film is preferably a film excellent in mechanical strength, heat stability and thickness evenness as well as transparency. Examples of a polymer used in the substrate film include polycarbonate, polyarylate, polysulfone, polyolefin, cycloolefin polymer, maleimide-based resin, polyesters such as PET and PEN, norbornene-based resin, acrylic resin, polystyrene, cellulose-based resin, modified products thereof, and mixtures made of two or more selected therefrom. The substrate film may be made of two or more films.

The thickness of the substrate film can be appropriately designed in accordance with the strength thereof or the like. In general, the thickness is 300 μm or less, preferably from 5 to 200 μm, more preferably from 10 to 100 μm in order to make the polarizing plate of the present invention thin and light.

When bond property is poor between the substrate film and the lyotropic crystalline, dichromatic colorant, an appropriate surface treatment or overcoat layer is applied onto one of the surfaces of the substrate film (i.e., the surface on which the solution containing the dichromatic colorant is to be applied) if necessary. The overcoat layer is not particularly limited, and examples of the material which constitutes the layer include alkyd resin, acrylic resin, epoxy resin, urethane resin, and isocyanate resin.

If necessary, a hard coat layer, an anti-glare layer, an antireflection layer or the like can be appropriately formed on the other surface of the substrate film, on which no polarizer is formed, (i.e., the surface to be watched or perceived). It is preferred to use, for the hard coat layer, for example, a crosslinkable transparent resin (such as a urethane acrylic or epoxy ultraviolet curing resin), which is made from a polyfunctional monomer and is irradiated with ultraviolet rays so as to be three-dimensionally crosslinked through a photocatalyst or the like and turned into a transparent hard film. The anti-glare layer is formed in a manner of making the other surface of the substrate film rough by a method known in the conventional art, such as sandblasting or emboss processing, in order to make fine irregularities in the surface, or in a manner of incorporating transparent fine particles into a transparent resin as described above and forming a transparent protective film therefrom. Examples of the transparent fine particles which can be used include inorganic fine particles made of silica, alumina, titania, zirconia, tin oxide, indium oxide, cadmium oxide, antimony oxide or the like, and organic fine particles made of crosslinked or non-crosslinked polymer grains. The average particle diameter of the transparent fine particles is not particularly limited, and is, for example, from 0.5 to 20 μm. The ratio of the incorporated transparent fine particles is not particularly limited, and in general the amount of the particles is preferably from 2 to 70 parts by weight for 100 parts of a transparent resin as described above, more preferably from 5 to 50 parts by weight therefor. The antireflection layer can be obtained by forming plural thin layers having different refractive indexes. The method for forming this layer may be vapor deposition, application or the like. From the viewpoint of productivity and costs, application is preferably used.

As described above, the substrate film on which the polarizer (coating film) is formed as described above, specifically, the polarizer side surface of the substrate film is bonded to the surface of the retardation film through a pressure-sensitive adhesive or an adhesive, thereby making it possible to yield an elliptically polarizing plate 1 having a layer structure as illustrated in FIG. 1A. By such lamination, the substrate film also functions as a protective film for protecting the polarizer.

The pressure-sensitive adhesive or adhesive is not particularly limited if it is excellent in transparency. For example, a known agent, such as an acrylic, silicone, polyester, polyurethane, or polyether agent, can be used.

The bond layer interposed between the polarizer and the retardation film is preferably made as thin as possible. For example, the thickness is preferably about 10 μm or less, more preferably about 5 μm or less.

Also, a coating layer having a polarizing function (a polarizer) can be formed on one of the surfaces of the retardation film by applying a solution containing a dichromatic colorant on the surface and then solidifying this solution. In this case, the retardation film and the polarizer are bonded directly to each other. A substrate film functioning as a protective film is laminated onto the other surface of this polarizer, onto which the retardation film is not bonded, through a pressure-sensitive adhesive or an adhesive, thereby making it possible to yield an elliptically polarizing plate 1 as illustrated in FIG. 1B.

Since the retardation film and the polarizer are bonded directly to each other, that is, they are bonded to each other without having any layer interposed therebetween, no retardation is generated by the interposed layer. Thus, polarized light to which a retardation is given by the passage of the light through the retardation film can be radiated, as it is, into the polarizer.

When the retardation film and the polarizer are stacked to each other to interpose an bond layer therebetween, it is necessary to pay attention to the prevention of inclusion of air foams or foreign substances. However, when the retardation film and the polarizer are bonded directly to each other as described above, the production process can also be made simple.

In the case of the polarizer stacked directly onto the retardation film, the thickness thereof can be set into 20 μm, preferably into 0.1 to 10 μm, even more preferably into 0.2 to 5 μm in the same manner as in the aforementioned case, where a polarizer is formed on a substrate film.

In the case that bond property between the retardation film and the lyotropic liquid crystalline, dichromatic colorant is poor, it is preferred to apply an appropriate surface treatment or overcoat layer onto the retardation film surface on which the colorant is to be applied as the need arises in the same manner as in the aforementioned embodiment, wherein a coating film is formed onto a substrate film. In the elliptically polarizing plate 1 having a layer structure as illustrated in FIG. 1B, it is allowable to form a hard coat layer, an anti-glare layer, an antireflection layer or the like, specific examples of the layers being described above, onto the other surface (i.e., the surface to be watched or perceived) of the substrate film as the need arises.

The elliptically polarizing plate of the present invention is preferably a circularly polarizing plate. In the circularly polarizing plate, for example, its retardation film (its λ/4 plate) and its polarizer (the aforementioned polarizer) are arranged to set the optical axis angle of each of them to 45°.

(Releasing Paper Sheet 2 or Bond Layer 3)

As the releasing paper sheet, a sheet having a thickness of 40 μm or more is preferably used. Examples of the releasing paper sheet include a synthetic resin film made of polyethylene, polypropylene, or polyethylene terephthalate, a rubber sheet, paper, cloth, nonwoven cloth, a net, a foamed sheet, metal foil, a laminate of two or more selected therefrom, and other appropriate products in a thin leaf form. If necessary, the releasing paper sheet may be a sheet coated with an appropriate releasing agent, such as a silicone agent, long-chain alkyl agent, fluorine-containing agent or molybdenum sulfide, or any other known releasing paper sheet. Of these, the synthetic resin film used as the releasing paper sheet is preferred from the viewpoint of its rigidity or handleability.

The material for the bond layer may be made of a pressure-sensitive adhesive or an adhesive excellent in transparency, such an acrylic, silicone or rubbery pressure-sensitive adhesive. Examples thereof are also described above. Of these, the acrylic pressure-sensitive adhesive is preferred. The weight-average molecular weight of the base polymer therein is preferably from about 300000 to 2500000.

The method for forming the bond layer is not particularly limited, and examples thereof include a method of applying the pressure-sensitive adhesive or adhesive onto the other surface (i.e., the surface on which the polarizer is not stacked) of the retardation film and then drying the agent, and a method of transferring, from a releasing sheet on which the bond layer is formed, the bond layer onto the surface. The thickness of this bond layer is not particularly limited, and is preferably from about 10 to 40 μm.

(Liquid Crystal Display Device and Image Display Device)

The elliptically polarizing plate of the present invention can be used in, for example, a liquid crystal panel, a liquid crystal display device, or other image display devices. The method for using the elliptically polarizing plate or the arrangement thereof is the same as in conventional liquid crystal panels or liquid crystal display devices.

The liquid crystal panel of the present invention is preferably a panel wherein the elliptically polarizing plate(s) of the present invention is/are arranged onto a single surface or both surfaces of a liquid crystal cell, in particular, onto at least the surface at the side of the display thereof. The liquid crystal display device of the present invention has such a liquid crystal panel.

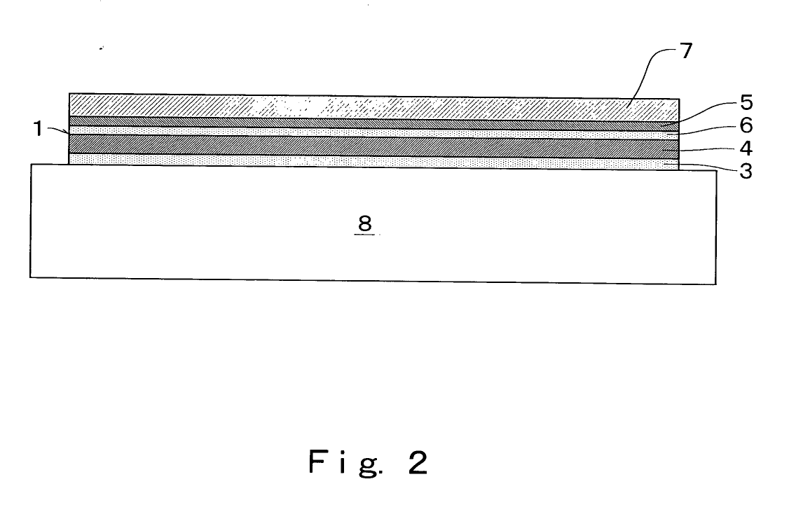

FIG. 2 illustrates, as an example thereof, a liquid crystal panel wherein the elliptically polarizing plate 1 illustrated in FIG. 1A is bonded to a single surface (at the side of the display) of a liquid crystal cell 8. In each of the elliptically polarizing plates 1 illustrated in FIGS. 1A and 1B, the releasing paper sheet 2 is peeled and then the plate 1 is bonded to the liquid crystal cell 8 through the bond layer 3. In the liquid crystal panel of this aspect, the substrate film 7 is positioned outside the polarizer 5 (the substrate film 7 is not interposed between the polarizer 5 and the liquid crystal cell 8); therefore, it is unnecessary to consider the retardation of the substrate film 7. Accordingly, for example, a birefringent film having a large retardation can be used as the substrate film 7. The elliptically polarizing plate illustrated in FIG. 1A or 1B may be bonded to each of the two surfaces of the liquid crystal cell.

The liquid crystal display device of the present invention can be made into an appropriate conventional structure, for example, a transmission type, a reflection type, or a transmission/reflection combination type structure wherein the elliptically polarizing plate is arranged on a single surface or both surfaces of a liquid crystal cell. Accordingly, the liquid crystal cell which constitutes the liquid crystal display device may be any liquid crystal cell. Thus, a liquid crystal cell of an appropriate type, for example, a simple matrix driving type cell, a typical example of which is a thin film transistor type cell, may be used. When the elliptically polarizing plates of the present invention are formed on both surface of a liquid crystal cell, the plates may be the same or different. At the time of forming the liquid crystal display device, one or more appropriate members can be arranged in the form of one or more layers at an appropriate position, examples of the members including a prism array sheet, a lens array sheet, a diffusion plate and a backlight.

The article in which the elliptically polarizing plate of the present invention is used is not limited to a liquid crystal display device as described above, and examples thereof include spontaneously light-emitting type image display devices such as an organic electroluminescent (EL) display, a plasma display (PD), and a field emission display (FED). When the elliptically polarizing plate of the present invention is used in each of these image display devices, it is preferred to arrange the elliptically polarizing plate at the side of its display screen. This makes it possible to remove, for example, outer light reflected on its electrode and improve the visibility thereof even in a bright environment. Especial limitation is not imposed on the image display device of the present invention except that the elliptically polarizing plate of the present invention is used therein instead of a conventional elliptically polarizing plate. Thus, any structure or arrangement known in the conventional art can be applied thereto.

### EXAMPLES

The retardation film of the present invention will be described in more detail by way of the following examples. However, the present invention is not limited to only these examples.

(Production of Retardation Film)

### Production Example 1

Into 100 mL of pyridine was suspended 11 g of polyvinyl alcohol (PVA) having a saponification degree of 88%, and the suspension was then stirred at 100° C. under a drying condition all night. To this reaction liquid was added 100 mL of pyridine, and the resultant liquid was cooled to 50° C. Thereafter, thereto was added 8.2 g of benzoyl chloride little by little, and then the resultant was stirred at 50° C. for 6 hours. To the reaction liquid was added 800 mL of acetone, and the resultant liquid was filtrated. The resultant filtrate was mixed with 7 L of distilled water, and the resultant was re-precipitated. This precipitated polymer (white precipitation) was separated by filtration, and put into distilled water of 50° C. temperature. The polymer was stirred to be washed. The precipitated polymer collected by performing a second separation by filtration was dried under a reduced pressure to yield 7.4 g of benzoyl-modified PVA. This benzoyl-modified PVA was analyzed by ¹H-NMR. As a result, the modification ratio of all carbon atoms in the PVA main chain based on the benzoyl groups was 13.5%.

Into 20 g of dimethylsulfoxide (DMSO) were dissolved 2 g of the resultant benzoyl-modified PVA and 0.2 g of glycerin to prepare a solution of the modified PVA. This modified PVA solution was applied onto a glass plate with an applicator, and dried to form a benzoyl-modified PVA film on the glass plate. This film was peeled from the glass plate, and drawn two times at 100° C. to produce a drawn film. This drawn film was used as a retardation film 1.

### Production Example 2

A drawn film was produced in the same way as in Production Example 1 except that the amount of benzoyl chloride was changed to 13.4 g. This was used as a retardation film 2. The amount of the resultant benzoyl-modified PVA was 7.8 g, and the modification ratio of all carbon atoms in the PVA main chain based on the benzoyl groups was 19.5%.

### Production Example 3

A drawn film was produced in the same way as in Production Example 1 except that the amount of benzoyl chloride was changed to 2.5 g. This was used as a retardation film 3. The amount of the resultant benzoyl-modified PVA was 7.5 g, and the modification ratio of all carbon atoms in the PVA main chain based on the benzoyl groups was 1.5%.

### Production Example 4

Into 100 mL of pyridine was suspended 11 g of PVA having a saponification degree of 88%, and the suspension was then stirred at 100° C. under a drying condition all night. To this reaction liquid was added 100 mL of pyridine, and the resultant liquid was cooled to 50° C. Thereafter, thereto was added 4.7 g of propyol acid little by little, and then the resultant was stirred at 50° C. for 6 hours. To the reaction liquid was added 800 mL of acetone, and the resultant liquid was filtrated. The resultant filtrate was mixed with 7 L of distilled water, and the resultant was re-precipitated. This precipitated polymer (white precipitation) was separated by filtration, and put into distilled water of 50° C. temperature. The polymer was stirred to be washed. The precipitated polymer collected by performing a second separation by filtration was dried under a reduced pressure to yield 6.7 g of propioloyl-modified PVA. This propioloyl-modified PVA was analyzed by ¹H-NMR. As a result, the modification ratio of all carbon atoms in the PVA main chain based on the propioloyl groups was 15%.

Into 20 g of DMSO were dissolved 2 g of the resultant propioloyl-modified PVA and 0.2 g of glycerin to prepare a solution of the propioloyl-modified PVA. This solution was applied onto a glass plate with an applicator, and dried to form a propioloyl-modified PVA film on the glass plate. This film was peeled from the glass plate, and drawn two times at 100° C. to produce a drawn film. This was used as a retardation film 4.

### Production Example 5

A drawn film was produced in the same way as in Production Example 4 except that the amount of propyol acid was changed to 6 g. This was used as a retardation film 5. The amount of the resultant propioloyl-modified PVA was 7.2 g, and the modification ratio of all carbon atoms in the PVA main chain based on the propioloyl groups was 18%.

### Production Example 6

A drawn film was produced in the same way as in Production Example 4 except that the amount of propyol acid was changed to 2 g. This was used as a retardation film 6. The amount of the resultant propioloyl-modified PVA was 6.4 g, and the modification ratio of all carbon atoms in the PVA main chain based on the propioloyl groups was 2.5%.

### Production Example 7

A benzoyl-modified PVA film (not drawn) was produced in the same way as in Production Example 1, and biaxially-drawn polyolefin films were stuck onto both surfaces of this film with a pressure-sensitive adhesive. This laminate was drawn two times at 100° C., and then the polyolefin films were peeled to yield a drawn, benzoyl-modified PVA film. This was used as a retardation film 7.

### Production Example 8

Into 20 g of methylene chloride was dissolved 2 g of polycarbonate. This solution was applied onto a glass plate with an applicator, and dried to form a polycarbonate film on the glass plate. This film was drawn 1.5 times at 160° C. to form a drawn film. This was used as a retardation film 8.

### Production Example 9

A non-modified PVA film was prepared in the same way as in Production Example 1 except that benzoyl chloride was not added. This was drawn to produce a drawn film. This was used as a retardation film 9.

(Wavelength Dispersion Property)

The property of each of the retardation films 1 to 9 yielded as described above was evaluated. A relationship between refractive indexes of each of the resultant retardation films is as follows.

Retardation film 1: nx>ny≈nz

Retardation film 2: nx>ny≈nz

Retardation film 3: nx>ny≈nz

Retardation film 4: nx>ny≈nz

Retardation film 5: nx>ny≈nz

Retardation film 6: nx>ny≈nz

Retardation film 7: nx>nz>ny

Retardation film 8: nx>ny≈nz

Retardation film 9: nx>ny≈nz

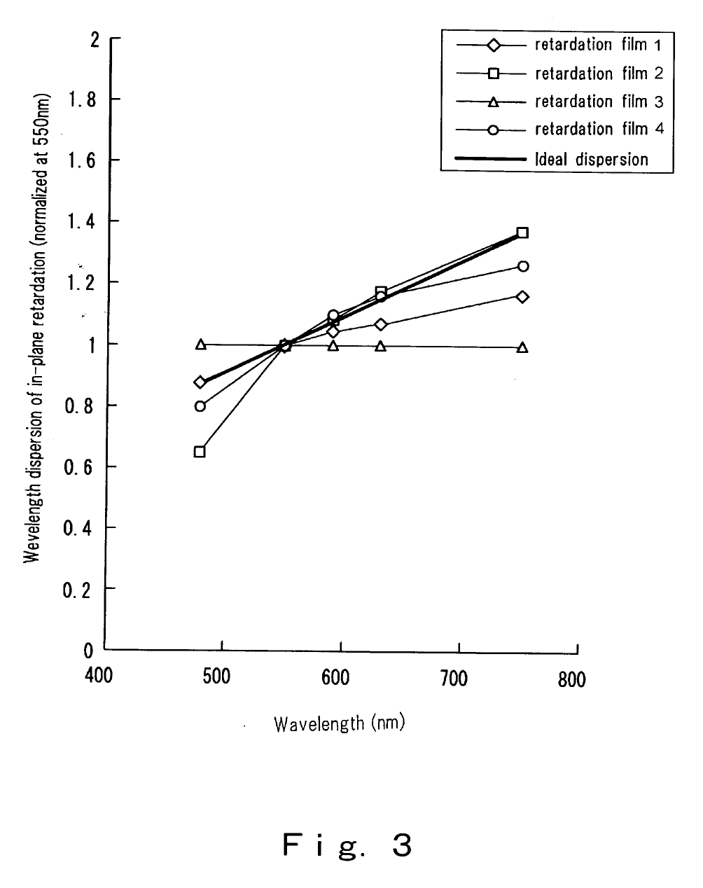

A birefringence measuring device (trade name: KOBRA-21ADH, manufactured by Oji Scientific Instruments) was used to measure the wavelength dispersion of the in-plane retardation in each of the retardation films 1 to 9. The results are shown in Table 1 and graphs shown in FIGS. 3 to 5. In each of the figures, the transverse axis represents wavelength, and the vertical axis represents the wavelength dispersion of the in-plane retardation Δnd (X nm)/Δnd (550 nm). FIGS. 3, 4 and 5 show the results of the retardation films 1 to 4, those of the retardation films 5 to 7, and those of the retardation films 8 and 9, respectively. In each of the graphs, an ideal reverse dispersion (ideal dispersion) is shown.

TABLE 1

| | Δnd (X nm)/Δnd (550 nm) | | | | |
|---|---|---|---|---|---|
| Xnm | 480 | 550 | 590 | 630 | 750 |
| Retardation film 1 | 0.879009 | 1 | 1.048834 | 1.059038 | 1.161808 |
| Retardation film 2 | 0.651393 | 1 | 1.082991 | 1.175886 | 1.371372 |
| Retardation film 3 | 0.998947 | 1 | 1.000239 | 1.000397 | 1.001863 |
| Retardation film 4 | 0.801641 | 1 | 1.092031 | 1.155008 | 1.260089 |
| Retardation film 5 | 0.617707 | 1 | 1.15948 | 1.240177 | 1.389654 |
| Retardation film 6 | 0.991441 | 1 | 1.005588 | 1.010172 | 1.015612 |
| Retardation film 7 | 0.885 | 1 | 1.045 | 1.080504 | 1.161 |
| Retardation film 8 | 1.0505 | 1 | 0.98 | 0.968 | 0.944 |
| Retardation film 9 | 1.007353 | 1 | 0.99682 | 0.944138 | 0.99066 |
| Ideal dispersion | 0.872727 | 1 | 1.072727 | 1.145455 | 1.363636 |

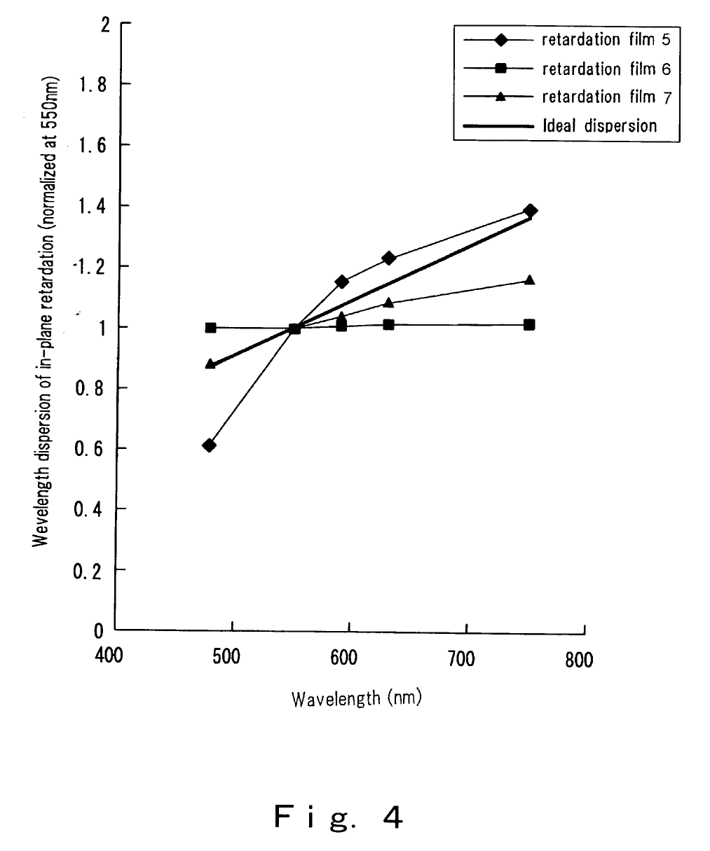

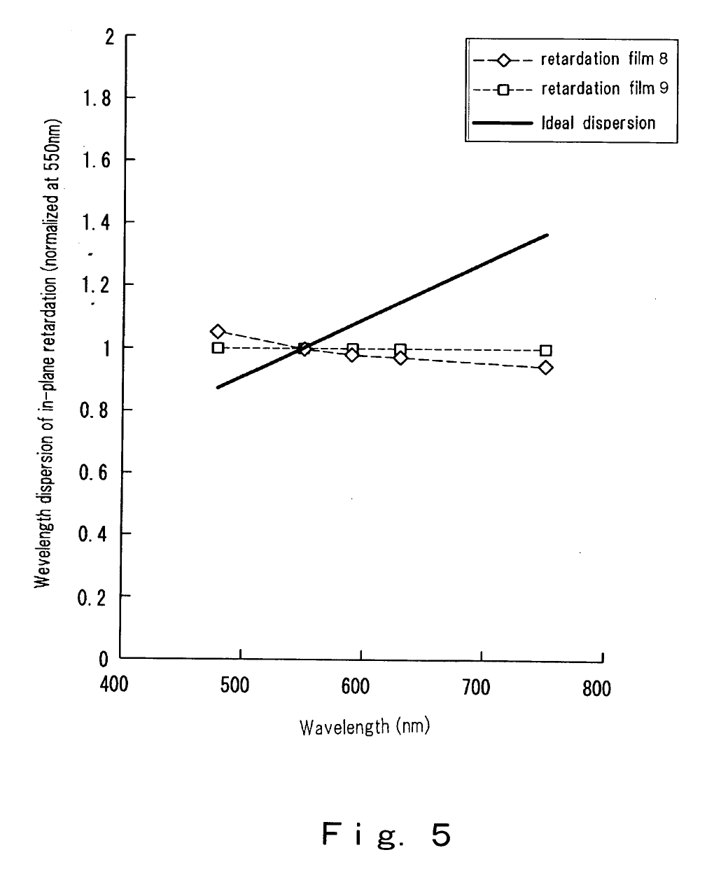

As shown in FIGS. 3 and 4, the retardation films 1 to 7 each exhibited a reverse wavelength dispersion that the in-plane retardation was larger from short wavelengths toward longer wavelengths. On the other hand, as illustrated in FIG. 5, the retardation film 8 exhibited a positive dispersion and the retardation film 9 exhibited a substantially flat wavelength dispersion, which was not any reverse dispersion.

(Retardation Change)

Next, about the retardation film 7, the retardation change thereof was checked.

Specifically, about the retardation film 7, the front face retardation and the retardation in the state that the retardation film 7 was inclined at an angle of 40° to the slow axis were measured, and the retardation change was checked. As a result, the retardation film 7 hardly gave any retardation change. The Nz coefficient was about 0.55 from the calculation thereof based on extrapolation (the calculation thereof from the measured birefringence index).

### Example 1

A solution containing a dichromatic dye (trade name: LC Polarizer TCF, manufactured by Optiva) was applied onto a surface of a biaxially drawn PET film (trade name: Lumirror, manufactured by Toray Industries) 38 μm in thickness by bar coating, so as to have an even thickness of 1 μm. Thereafter, the applied layer was naturally dried to form a polarizer made of the coating film. Next, this polarizer and the retardation film 1 were stacked onto each other through a polyvinyl alcohol adhesive (trade name: Poval NH-18, manufactured by Nippon Synthetic Chemical Industry) so as to set the angle between the absorption axis of the polarizer and the slow axis of the retardation film to 45 degrees. Furthermore, a pressure-sensitive adhesive layer 20 μm in thickness was transferred onto the rear face of this retardation film 1 (the surface onto which the polarizer was not bonded) by a transferring method, thereby producing an elliptically polarizing plate according to Example 1.

The total thickness (from the PET film to the pressure-sensitive adhesive layer) of the resultant elliptically polarizing plate was 105 μm.

The measurement of the thickness was performed with a micrometer (manufactured by Mitutoyo).

### Example 2

An elliptically polarizing plate according to Example 2 was produced in the same way as in Example 1 except that the retardation film 2 was used instead of the retardation film 1.

The total thickness of the resultant elliptically polarizing plate was 131 μm.

### Example 3

An elliptically polarizing plate according to Example 3 was produced in the same way as in Example 1 except that the retardation film 3 was used instead of the retardation film 1.

The total thickness of the resultant elliptically polarizing plate was 101 μm.

### Example 4

An elliptically polarizing plate according to Example 4 was produced in the same way as in Example 1 except that the retardation film 4 was used instead of the retardation film 1.

The total thickness of the resultant elliptically polarizing plate was 105 μm.

### Example 5

An elliptically polarizing plate according to Example 5 was produced in the same way as in Example 1 except that the retardation film 5 was used instead of the retardation film 1.

The total thickness of the resultant elliptically polarizing plate was 130 μm.

### Example 6

An elliptically polarizing plate according to Example 6 was produced in the same way as in Example 1 except that the retardation film 6 was used instead of the retardation film 1.

The total thickness of the resultant elliptically polarizing plate was 104 μm.

### Example 7

An elliptically polarizing plate according to Example 7 was produced in the same way as in Example 1 except that the retardation film 7 was used instead of the retardation film 1.

The total thickness of the resultant elliptically polarizing plate was 134 μm.

### Comparative Example 1

An elliptically polarizing plate according to Comparative Example 1 was produced in the same way as in Example 1 except that the retardation film 8 was used instead of the retardation film 1.

The total thickness of the resultant elliptically polarizing plate was 105 μm.

### Comparative Example 2

An elliptically polarizing plate according to Comparative Example 2 was produced in the same way as in Example 1 except that the retardation film 9 was used instead of the retardation film 1.

The total thickness of the resultant elliptically polarizing plate was 110 μm.

### Comparative Example 3

An elliptically polarizing plate according to Comparative Example 3 was produced in the same way as in Example 1 except that an iodine-adsorbed polyvinyl alcohol drawn film sandwiched between triacetylcellulose (thickness: 190 μm) (trade name: SEG 5425, manufactured by Nitto Denko Corp) was used as a polarizer instead of the polarizer made of the PET film and the coating film.

The total thickness of the resultant elliptically polarizing plate was 206 μm.

### Comparative Example 4

An elliptically polarizing plate according to Comparative Example 4 was produced in the same way as in Example 2 except that an iodine-adsorbed polyvinyl alcohol drawn film sandwiched between triacetylcellulose (thickness: 190 μm) (trade name: SEG 5425, manufactured by Nitto Denko Corp) was used as a polarizer instead of the polarizer made of the PET film and the coating film.

The total thickness of the resultant elliptically polarizing plate was 234 μm.

As described above, the retardation films of Examples 1 to 7 were able to be formed so as to have a smaller total thickness than the elliptically polarizing plates of Comparative Examples 3 and 4.

The elliptically polarizing plates of Examples 1 to 7 and Comparative Examples 1 and 2 were each arranged onto a surface of a reflecting plate wherein aluminum was evaporated on PET (an aluminum evaporated film surface), and a color reflected thereon was evaluated with a device (trade name: MCPD 3000, manufactured by Otsuka Electronics).

In the elliptically polarizing plates of Examples 1 to 7, absolute vales of their a* value and b* value were smaller than those in the plates of Comparative Examples 1 and 2. It can be said from this matter that the colors of the elliptically polarizing plates of Examples 1 to 7 were nearer to achromatic color, and less colored.

1. An elliptically polarizing plate comprising:
a retardation film having a film comprising a polymer which has, as its main chain, a polyol skeleton having a side chain substituted with at least one chemical group selected from the group consisting of an aromatic carbonyl group, an aryl-substituted lower alkylcarbonyl group, and an unsaturated aliphatic carbonyl group, the chemical group being bonded to an oxygen atom in the polyol skeleton side chain; and
a polarizer stacked over the retardation film,
wherein
the polarizer is made of a coating film obtained by applying a dichromatic colorant.

2. The elliptically polarizing plate according to claim 1,
wherein
the polarizer is the coating film obtained by applying the dichromatic colorant to a substrate film, and this coating film is stacked over the retardation film with a pressure-sensitive adhesive or an adhesive interposed therebetween.

3. The elliptically polarizing plate according to claim 1,
wherein
the polarizer is stacked directly onto the retardation film.

4. The elliptically polarizing plate according to claim 1,
wherein
the polarizer is formed to have a film thickness of 20 μm or less.

5. The elliptically polarizing plate according to claim 1,
wherein
the aromatic carbonyl group is represented by the following formula (1) or (2):
(Chemical Formula 1) 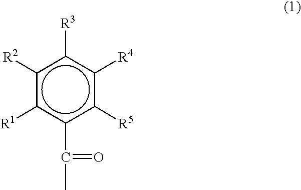
wherein R¹, R², R³, R⁴ and R⁵ may be the same or different and each represent a hydrogen atom or halogen atom, or a hydroxyl, methyl, ethyl, halogenated methyl, halogenated ethyl or nitro (—NO₂) group, or
(Chemical Formula 2) 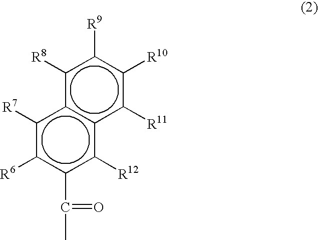
wherein R⁶, R⁷, R⁸, R⁹, R¹⁰, R¹¹ and R¹² may be the same or different and each represent a hydrogen atom or halogen atom, or a hydroxyl, methyl, ethyl, halogenated methyl, halogenated ethyl or nitro (—NO₂) group.

6. The elliptically polarizing plate according to claim 1,
wherein
the aryl-substituted lower alkylcarbonyl group is represented by Ar—(CH₂)ₙ—CO— wherein Ar is an aromatic ring and n is an integer of 1 to 2.

7. The elliptically polarizing plate according to claim 6,
wherein
the aryl-substituted lower alkylcarbonyl group is represented by the following formula (3) or (4):
(Chemical Formula 3) 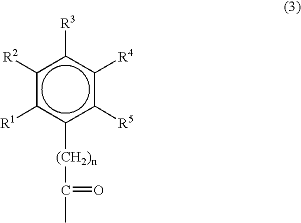
wherein R¹, R², R³, R⁴ and R⁵ may be the same or different and each represent a hydrogen atom or halogen atom, or a hydroxyl, methyl, ethyl, halogenated methyl, halogenated ethyl or nitro (—NO₂) group, and n is an integer of 1 to 2, or
(Chemical Formula 4) 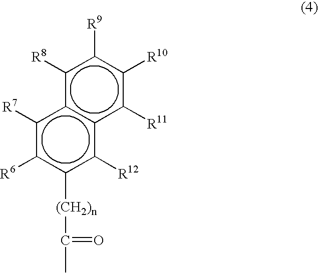
wherein R⁶, R⁷, R⁸, R⁹, R¹⁰, R¹¹ and R¹² may be the same or different and each represent a hydrogen atom or halogen atom, or a hydroxyl, methyl, ethyl, halogenated methyl, halogenated ethyl or nitro (—NO₂) group, and n is an integer of 1 to 2.

8. The elliptically polarizing plate according to claim 1,
wherein
the unsaturated aliphatic carbonyl group is represented by any one of the following formulae (5) to (7):
(Chemical Formula 5)
(Chemical Formula 6)
(Chemical Formula 7) 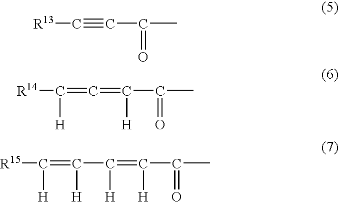
wherein R¹³, R¹⁴ and R¹⁵ each represent a hydrogen atom or halogen atom, or a hydroxyl, methyl, ethyl, halogenated methyl, halogenated ethyl or nitro (—NO₂) group.

9. The elliptically polarizing plate according to claim 1,
wherein
the retardation film is a retardation film wherein the in-plane retardation in wavelengths of 450 to 650 nm becomes smaller toward shorter wavelengths therein and becomes larger toward longer wavelengths therein.

10. The elliptically polarizing plate according to claim 1,
wherein
the dichromatic colorant comprises an organic colorant represented by the following general formula (15): (chromogen)(SO₃M)ₙ wherein M represents a cation.

11. A liquid crystal panel comprising a liquid crystal cell having the elliptically polarizing plate according to claim 1.

12. A liquid crystal display device having the elliptically polarizing plate according to claim 1.

13. A liquid crystal display device having the liquid crystal panel according to claim 11.

14. An image display device having the elliptically polarizing plate according to claim 1.
